(19) United States
(12) Patent Application Publication
(10) Pub. No.: US 2012/0223907 A1
(43) Pub. Date: Sep. 6, 2012

(54) METHOD AND APPARATUS FOR PROVIDING TOUCH INFORMATION OF 3D-OBJECT TO USER

(75) Inventors: Je-Ha Ryu, Buk-gu (KR); Hyun-Gon Kim, Buk-gu (KR)

(73) Assignee: GWANGJU INSTITUTE OF SCIENCE AND TECHNOLOGY, Buk-gu, Gwangju (KR)

(21) Appl. No.: 13/508,809

(22) PCT Filed: Nov. 9, 2010
(86) PCT No.: PCT/KR2010/007867

§ 371 Date: May 9, 2012

(30) Foreign Application Priority Data
Nov. 9, 2009 (KR) 1020090107691

(51) Int. Cl. G06F 3/041

(52) U.S. Cl. 345/173

(57) ABSTRACT

Disclosed are a method and an apparatus for providing the touch information of a 3-D object. The method includes creating a hexahedral bounding box around the 3-D object, acquiring a depth information image for each side of the hexahedral bounding box, creating six touch attribute images corresponding to six depth information images, and providing a touch attribute of at least one of the six touch attribute images to a user.

### BACKGROUND OF THE INVENTION

1. Field of the Invention

The present invention relates generally to a haptic technology. More particularly, the present invention relates to a method and an apparatus for providing the touch information of a 3-D object.

2. Related Art of the invention

In general, in order to touch a 3-D virtual object through a touch device, after storing touch attributes, such as stiffness, friction, and roughness, in the 3-D virtual object through a touch modeling software, the stored touch attributes are obtained when touching the 3-D virtual object in a virtual reality, so that the touch sense for the 3-D virtual object can be expressed.

The 3-D virtual object to which the touch attributes are applied allows a user to feel hard, soft, smooth, or rough of the surface of the 3-D virtual object when the user touches the 3-D virtual object. Such a touch modeling technology according to the related art includes an object-oriented modeling scheme, a mesh-based modeling scheme, or a voxel texture-based modeling scheme.

According to the object-oriented modeling scheme, when a touch sense is applied to the 3-D object, a basic unit is an object, and one object may express one touch attribute. According to the mesh-based modeling scheme, a mesh may have a single touch attribute. The single touch attribute does not refer to a single attribute representing one of stiffness, friction, and roughness, but refers to a single touch sense resulting from the combination of the stiffness, friction, and roughness.

The object-oriented modeling scheme or the mesh-based modeling scheme is based on the minimum unit (object or mesh) for the modeling. In order to apply various touch attributes to the minimum unit, the touch attributes may be stored through partitioning in the case of the object-oriented modeling scheme, or through subdivision in the case of the mesh-based modeling scheme.

Therefore, in the modeling-based scheme, a user must additionally perform another work in addition to touch modeling, and may not express a non-uniform touch attribute. The non-uniform touch attribute refers to that the touch attributes of the surface are not uniform according to the locations.

Meanwhile according to the voxel texture-based modeling scheme, the 3-D virtual object is converted into a voxel, and the voxel is mapped with an image texture (place that texture attributes are stored). Therefore, in the case of the voxel texture-based modeling scheme, a lookup table must be constructed in order to link voxels to the image texture. The size of the lookup table is varied according to resolutions when 3-D virtual objects are converted into voxels. Therefore, as the resolutions are increased, the lookup table is exponentially increased. The size of the lookup table may be increased corresponding to the cube of the resolution.

### SUMMARY OF THE INVENTION

Accordingly, the present invention has been made keeping in mind the above problems occurring in the prior art, and an object of the present invention is to provide a method and an apparatus capable of expressing a touch sense in a virtual reality by storing touch information by using six touch attribute images and reading necessary touch information in rendering, so that required touch information can be stored and expressed when a user wants to feel the touch sense for a 3-D virtual object through the haptic device in the virtual reality.

Another object of the present invention is to provide a method and an apparatus capable of storing non-uniform touch attributes, which cannot be provided through a touch modeling scheme according to the related art, and several touch attributes without a storage place required for mapping.

Still another object of the present invention is to provide a method and an apparatus capable of matching the surface of the 3-D virtual object to the touch attribute images by using depth information and an IHIP acquired in rendering in order to search for the six touch attribute images matching to the surface of the 3-D virtual object.

However, objects of the present invention are not limited to the above object, but those skilled in the art can infer other objects from the following description.

To accomplish these objects, according to one aspect of the present invention, there is provided a method for providing touch information of a 3-D object. The method includes creating a hexahedral bounding box around the 3-D object, acquiring a depth information image for each side of the hexahedral bounding box, creating six touch attribute images corresponding to six depth information images, and providing a touch attribute of at least one of the six touch attribute images to a user.

According to another aspect of the present invention, there is provided an apparatus for providing touch information of a 3-D object. The apparatus includes a bounding box generator for creating a hexahedral bounding box around the 3-D object, a depth information acquiring module for acquiring a depth information image for each side of the hexahedral bounding box, a touch attribute generator for creating six touch attribute images corresponding to the six depth information images, and a haptic device for providing a touch attribute of at least one of the six touch attribute images to a user.

As described above, according to the method and the apparatus for providing the touch information of the 3-D object, different from the related art, the lookup table is not required, and an additional work such as partitioning or subdivision to provide the non-uniform touch attributes is not required. Accordingly, various touch attributes can be expressed without a large memory region and the operation of a processor.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a block diagram showing the structure of an apparatus for providing a touch sense according to one embodiment of the present invention;

FIG. 2 is a view showing an example of setting a bounding box with respect to a 3-D object;

FIGS. 3(a) to 3(c) are views showing examples of resolutions set for touch attribute images;

FIG. 4 illustrates that related coordinates are recorded at the same position on a depth information image and a touch attribute image;

FIG. 5 illustrates the relation between the 3-D object, six-directional depth information images, and six-directional touch attribute images;

FIG. 6 illustrates a case that an ideal haptic interaction point (IHIP) is applied to FIG. 5; and

FIG. 7 is a flowchart showing a method for providing touch information of the 3-D object according to one embodiment of the present invention.

### DETAILED DESCRIPTION OF THE INVENTION

Differently from the related art, the present invention employs a scheme of mapping a 3-D virtual object with six touch attribute images. A touch attribute image has touch information and touch attributes are recorded in regions of the touch attribute image corresponding to a real image. In other words, six pieces of depth image information are used to map the 3-D virtual object with six touch attribute images.

Different from the voxel texture-based modeling scheme, the above scheme does not require a lookup table, and is not subordinate to a surface. In addition, the scheme does not require complex skills such as partitioning and subdivision in order to express non-uniform touch attributes. Further, the above scheme stores various touch senses existing in a real world, for example, stiffness, friction, vibration, and temperature by using six touch attribute images, so that the touch senses can be represented in a virtual environment.

The present invention has advantages different from the related art in the following two aspects.

Recognition Aspect

As the virtual world has been developed, a system to stimulate a touch sense as well as a visible sense and an audible sense can be developed. In order to express the touch sense, when the touch sense is provided to a user in the virtual world, the same touch sense as that of a real object must be provided to the user so that the user can feel the virtual world like the real world. Therefore, if the surface of the real object does not represent single touch information, the user may not concentrate on the virtual world. Accordingly, if an existing modeling scheme is used to perform modeling with respect to a virtual object having various pieces of touch information in terms of a tactile sense, an additional work is required or a great amount of data information (mapping information) is required.

The present invention is designed to suggest non-uniform attributes by storing the touch attributes of a 3-D object in six touch attribute images without storing the mapping information so that the user in the virtual world can obtain information enable the concentration on the virtual world.

Engineering Aspect

The existing touch modeling scheme cannot provide non-uniform touch attributes. Even if the non-uniform touch attributes are provided, a great amount of mapping information must be stored to provide the non-uniform touch information. The present invention can effectively provide the non-uniform touch information to a 3-D virtual object. In addition, according to the present invention, redundancy mapping information is not required (memory can be effectively used), and various kinds of touch attributes can be provided.

The above and other aspects, features and advantages of the present invention will be more apparent from the following detailed description taken in conjunction with the accompanying drawings. However, the present invention is not limited to the below-described embodiments but may be realized in various forms. The embodiments of the present invention only aim to fully disclose the present invention and inform those skilled in the art of the scope of the present invention. Thus, the present invention is defined only by the scopes of the claims. The same or like reference numerals refer to the same or like elements throughout the specification.

Hereinafter, one embodiment of the present invention will be described with reference to accompanying drawings.

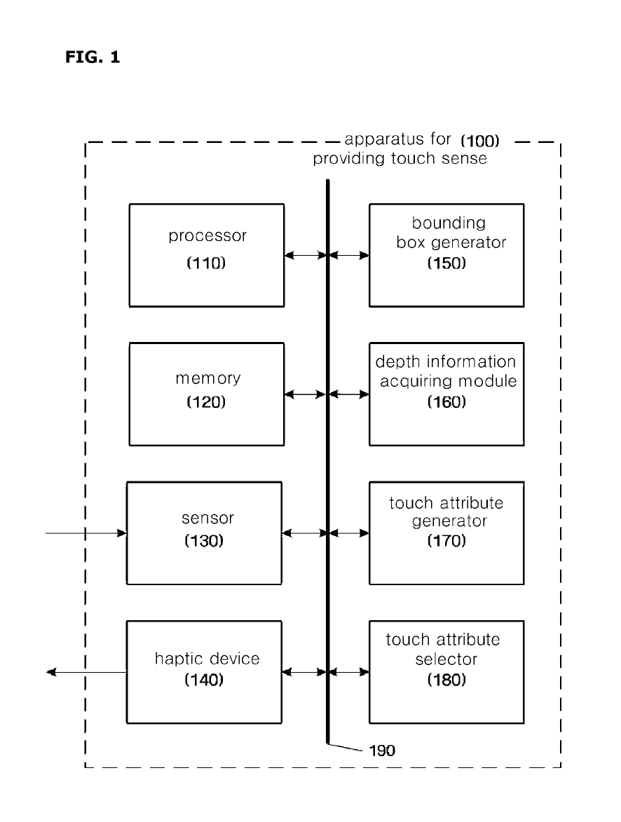

FIG. 1 is a block diagram showing the structure of an apparatus 100 for providing a touch sense according to one embodiment of the present invention. The apparatus 100 for providing the touch sense may include a personal computer, which is commercially available, a portable electronic device, or a computing or processing device having less complexity (devices dedicated for at least one specific work). In addition, the apparatus 100 for providing the touch sense may include a cellular phone, a PDA, or a potable game system. In addition, the apparatus 100 for providing the touch sense may include a terminal dedicated for an interactive virtual reality environment such as a game system.

As shown in FIG. 1, for example, the apparatus 100 for providing the touch sense may include a processor 110, a memory 120, a sensor 130, a haptic device 140, a bounding box generator 150, a depth information acquiring module 160, a touch attribute generator 170, and a touch attribute selector 180.

The processor 110 may include a microprocessor which is commercially available and can perform a typical processing operation. In addition, the processor 110 may include an application-specific integrated circuit (ASIC) or the combination of ASICs. The processor 110 may be designed to perform at least one specific function or operate at least one specific device or application.

In addition, the processor 110 may include an analog circuit, or a digital circuit, or may include the combination of a plurality of circuits.

In addition, the processor 110 may selectively include at least one individual sub-processor or coprocessor. For example, the processor 11 may include a graphic coprocessor enabling graphic rendering, a mathematic coprocessor that can effectively perform a complex computation, a controller to control at least one device, or a sensor interface to receive sense information from at least one sense device.

The memory 120 may include at least one memory. For example, the memory 120 may include a read only memory (ROM), or a random access memory (RAM). The memory 120 may include different types of memories which are suitable for storing data sufficient to be searched by the processor 110 and are not shown in FIG. 1. As well as a memory having another appropriate form, the memory 120 may include an electrically programmable ROM (EPROM), an erasable electrically programmable ROM (EEPROM), or a flash memory.

The processor 110 can communicate with the memory 120, store data in the memory 120, or search for data that have been previously stored in the memory 120. In addition, the processor 110 controls the whole operations of the remaining blocks shown in FIG. 1 through the bus 190.

The haptic device 140 can be configured to output basic haptic effects such as a periodic haptic effect, a magnitude-sweep haptic effect, or a timeline haptic effect. The above haptic effects will be described below. According to at least one embodiment of the present invention, the haptic device 140 may include at least one force-applying mechanism. For example, according to the force-applying mechanism, a sensing force can be provided to the user of the apparatus 100 for providing the touch sense through a housing of the apparatus 100 for providing the touch sense. For example, the force may be transmitted in the form of a vibration motion caused by the haptic device 100 such as the large size piezo-electric device or another vibration operation device, or the form of resistance caused by the haptic device 140. According to one embodiment of the present invention, the haptic device 140 provides a touch attribute of at least one of the six touch attribute images, which are generated from the touch attribute generator, to the user.

According to one embodiment of the present invention, the sensor 130 can receive the input from the user or the haptic device 140, or detect at least one physical parameter. For example, the sensor 130 may measure a speed, strength, acceleration, or another parameter related to a haptic effect output by the haptic device 140. Similarly, the sensor 130 may detect environmental conditions around a processor system. The sensor 130 may interact with the processor 110 or communicate with the processor 110 through the sensor interface (not shown) in the processor 110.

The bounding box generator 150 generates a bounding box having the hexahedral shape. The size and the generation direction of the bounding box may be varied according to the selection of those skilled in the art.

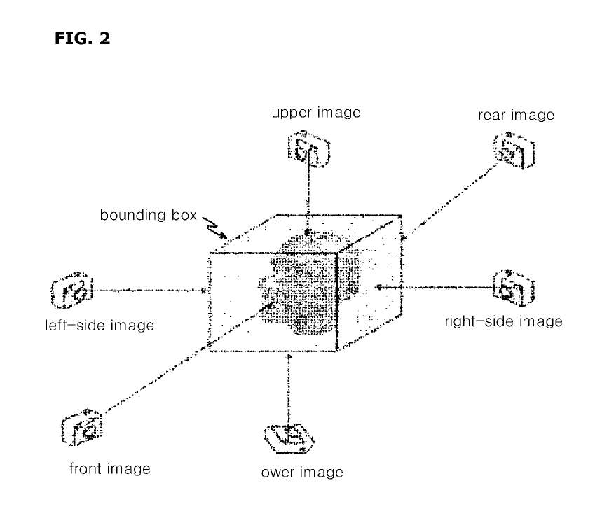

As shown in FIG. 2, the depth information acquiring module 160 acquires six depth information images by placing virtual cameras at the six sides of the bounding box. The virtual cameras generate six depth information images, respectively in six directions to face the 3-D object that has been previously formed. The depth information images may not be calculated separately, but be simply obtained by projecting the previously-created surface coordinates of the 3-D object onto the sides of the bounding box, respectively.

The touch attribute generator 170 generates six touch attribute images corresponding to the six depth information images. In detail, the touch attribute generator 17 generates the touch attribute images by matching with the six depth information images obtained for the six sides of the bounding box.

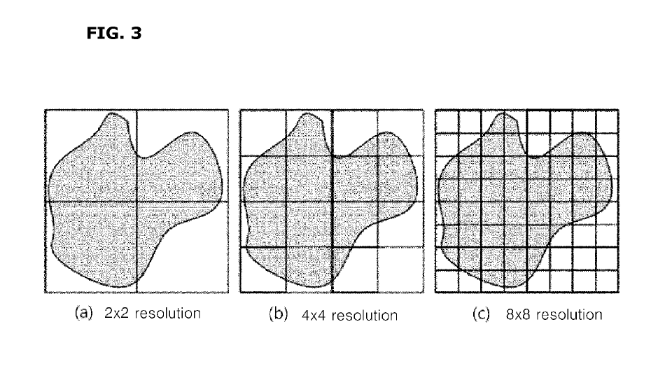

The touch attribute images can represent the 3-D virtual object in detail in terms of a touch sense according to the selected resolution. FIG. 3(a) shows a case of expressing one object by using four pieces of touch information, FIG. 3(b) shows a case of expressing the object by using 16 pieces of touch information, and FIG. 3(c) shows a case of expressing the object by using 64 pieces of touch information. This refers to that touch information can be expressed in more detail as the resolution is increased.

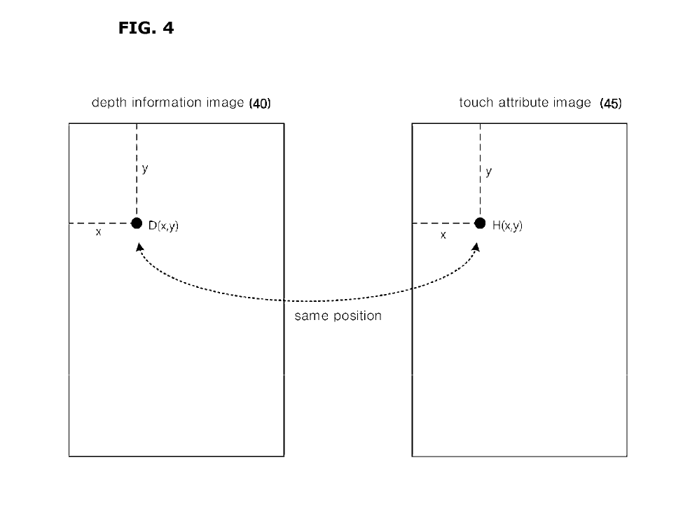

However, according to the present invention, the depth information image and the corresponding touch attribute image have corresponding data at the same positions. For example, as shown in FIG. 4, if a depth information image 40 represents a front image of FIG. 2, a touch attribute image 45 corresponding to the front image must be created. The data D(x, y) on the depth information image 40 refers to a depth from specific coordinates (x, y) to the 3-D surface when viewed from the front. Therefore, the touch attribute of the surface of the 3-D object must be recorded on the same coordinates (x, y) of the touch attribute image 45. Therefore, as shown in FIG. 3, the touch attribute generator 170 sets the resolution of the depth information image 40 to a value equal to the resolution of the touch attribute image 45 after the resolution of the touch attribute image 45 has been set. Accordingly, since the touch attribute image 45 has the touch attributes in the region corresponding to the depth information image 40, an additional lookup table is not required.

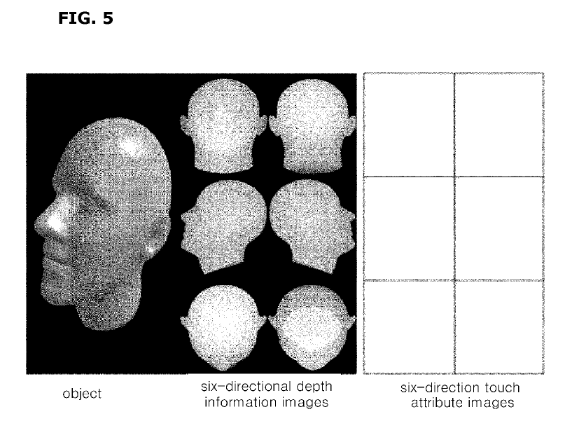

FIG. 5 shows the relation among the 3-D object, six-directional depth information images, and six-directional touch attribute images according to one embodiment of the present invention.

The object modeled in 3-D contains coordinate information of each surface of the object, and the 3-D coordinate information informs data of each of the six-directional depth information images. In addition, each position of the six-directional touch attribute images corresponds to each position of the six-directional depth information images, and has touch information corresponding thereto. As shown in FIG. 5, the touch attribute generator 170 sets the resolution of the empty touch attribute image and records various touch attributes at each pixel according to the set resolution.

The six-directional touch attribute images are used to express a single touch attribute through the combination thereof. The single touch attribute does not refer to a single attribute representing one of stiffness, friction, roughness, temperature, vibration, and impacts, but represent a single touch sense resulting from the combination thereof. Therefore, if several sets of six-directional touch attribute images exist, several touch attributes can be expressed. For example, in order to express three touch senses, 18 touch attribute images (6×3=18), that is, three sets of six-directional touch attribute images are required.

Meanwhile, a 3-D pointer, which is an ideal haptic interaction point (IHIP), may be used for surface selection of the 3-D virtual object.

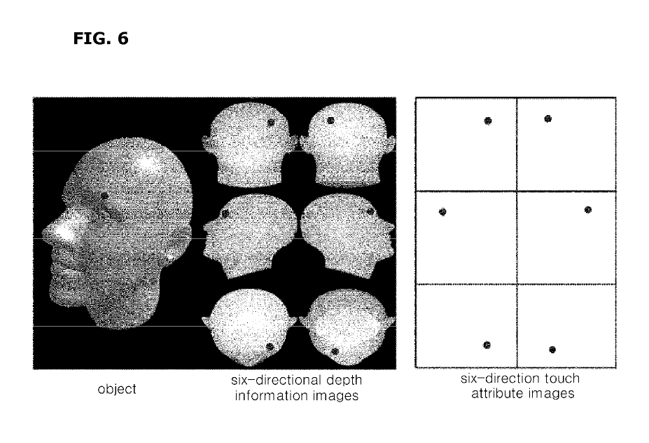

If points detected by the sensor 130, that is, points at which the user interacts with the object, are marked on the 3-D object by using IHIPs, six depth information images and six touch attribute images can obtain corresponding coordinates. In FIG. 6, circular points represent the IHIPs. Therefore, specific positions of the depth information images and the touch attribute images can be tracked.

The touch attribute selector 180 can select three left images by determining the three left images among the six depth information images as desirable images according to the IHIPs based on the depth information images. This is because three right images of the six depth information images are determined as invalid images by checking data of the depth information images as shown in FIG. 6. For example, the IHIP marked on the left eye are not recognized as the IHIP marked on the right eye.

The three left images selected through the above scheme are similarly applied to the touch attribute images. Therefore, the touch attribute generator 170 can store the desirable touch information in the IHIPs of the three left images selected by the touch attribute selector 180. The touch information can be stored on the whole surface of the 3-D object by repeatedly performing the position track based on the IHIPs and the information storage thereof.

Meanwhile, if the user interacts (e.g., touches) with the 3-D object after all data have been recorded on the touch attribute images, desirable touch information can be provided. If the user makes contact with at least one point on the 3-D object surface, the sensor 130 detects the contact and the detected result is transferred to the processor 110. The processor 100 reads the touch information corresponding to the specific position from the touch attribute images stored in the memory 120. The haptic device 140 generates physical outputs (vibration, temperature, etc.) corresponding to the touch information and provides the physical outputs to the user.

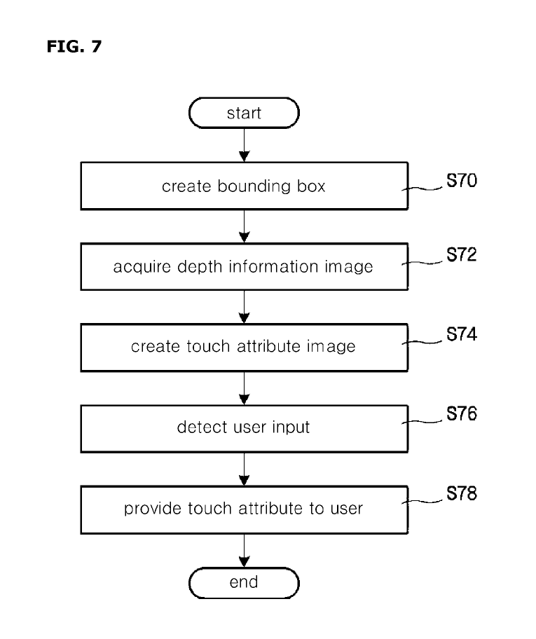

FIG. 7 is a flowchart showing the method of providing the touch information of the 3-D object according to one embodiment of the present invention.

The bounding box generator 150 generates a hexagonal bounding box around the 3-D object (step S70).

Thereafter, the depth information acquiring module 160 acquires the depth information images for the sides of the bounding box (step S72). The depth information images are acquired by the virtual cameras at the sides of the bounding box.

The touch attribute generator 170 generates six touch attribute images corresponding to the six depth information images (step S74). In this case, the touch attribute generator 170 sets the resolution of the six touch attribute images to a value equal to the resolution of the depth information images. When the touch attribute generator 170 records the touch information, the touch attribute selector 180 selects at least single touch attribute image corresponding to the contact position of the 3-D pointer from six touch attribute images by using the depth information image.

If a specific input exists from a user, that is the user interaction exists after the touch attribute image has been created, the sensor 130 detects the specific input (step S76). In other words, the sensor 130 detects at least one contact point of the surface of the 3-D object and the user.

The haptic device 140 provides touch attributes of at least one of the six touch attribute images to the user (step S78).

Although a preferred embodiment of the present invention has been described for illustrative purposes, those skilled in the art will appreciate that various modifications, additions and substitutions are possible, without departing from the scope and spirit of the invention as disclosed in the accompanying claims.

As described above, the present invention provides a method and an apparatus capable of expressing a touch sense in a virtual reality by storing touch information by using six touch attribute images and reading necessary touch information in rendering, so that required touch information can be stored and expressed when a user wants to feel the touch sense for a 3-D virtual object through the haptic device in the virtual reality.

What is claimed is:

1. A method for providing touch information of a 3-D object, the method comprising:
creating a hexahedral bounding box around the 3-D object;
acquiring a depth information image for each side of the hexahedral bounding box;
creating six touch attribute images corresponding to six depth information images; and
providing a touch attribute of at least one of the six touch attribute images to a user.

2. The method of claim 1, wherein the providing of the touch attribute to the user comprises providing a plurality of touch attributes by providing plural sets of touch attribute images.

3. The method of claim 1, further comprising setting resolution of the six touch attribute images equal to resolution of the depth information images.

4. The method of claim 1, wherein the creating of the six touch attribute images comprises recording a touch attribute in a position where a pointer, which is marked in one point of the 3-D object, is represented in the touch attribute images.

5. The method of claim 4, wherein the creating of the six touch attribute images further comprises selecting at least single touch attribute image from the six touch attribute images by using the depth information images.

6. The method of claim 1, wherein each depth information image is acquired by a virtual camera located at each side of the bounding box.

7. The method of claim 1, further comprising sensing contact of a user making contact with at least one point on a surface of the 3-D object.

8. An apparatus for providing touch information of a 3-D object, the apparatus comprising:
a bounding box generator for creating a hexahedral bounding box around the 3-D object;
a depth information acquiring module for acquiring a depth information image for each side of the hexahedral bounding box;
a touch attribute generator for creating six touch attribute images corresponding to the six depth information images; and
a haptic device for providing a touch attribute of at least one of the six touch attribute images to a user.

9. The apparatus of claim 8, wherein the haptic device provides a plurality of touch attributes by using plural sets of touch attribute images.

10. The apparatus of claim 8, wherein the touch attribute generator sets resolution of the six touch attribute images equal to resolution of the depth information images.

11. The apparatus of claim 8, wherein the touch attribute generator records a touch attribute in a position where a pointer, which is marked in one point of the 3-D object, is represented in the touch attribute images.

12. The apparatus of claim 11, further comprising a touch attribute selector for selecting at least single touch attribute image from the six touch attribute images by using the depth information images.

13. The apparatus of claim 8, wherein each depth information image is acquired by a virtual camera located at each side of the bounding box.

14. The apparatus of claim 8, further comprising a sensor for sensing contact of a user making contact with at least one point on a surface of the 3-D object.
